(19) United States
(12) Patent Application Publication
(10) Pub. No.: US 2023/0226949 A1
(43) Pub. Date: Jul. 20, 2023

(54) VEHICLE OPERATION MANAGEMENT METHOD, VEHICLE OPERATION MANAGEMENT DEVICE AND NON-TRANSITORY COMPUTER READABLE RECORDING MEDIUM STORING VEHICLE OPERATION MANAGEMENT PROGRAM

(71) Applicant: Panasonic Intellectual Property Corporation of America, Torrance, CA (US)

(72) Inventors: Eiichi NAITO, Kyoto (JP); Takahiro KUDOH, Kyoto (JP)

(73) Assignee: Panasonic Intellectual Property Corporation of America, Torrance, CA (US)

(21) Appl. No.: 18/126,131

(22) Filed: Mar. 24, 2023

Related U.S. Application Data
(63) Continuation of application No. PCT/JP2021/016776, filed on Apr. 27, 2021.

(30) Foreign Application Priority Data
Oct. 2, 2020 (JP) 2020-167533

(51) Int. Cl. B60L 58/16; B60L 58/18; G01C 21/34

(52) U.S. Cl. CPC B60L 58/16; B60L 58/18; G01C 21/3453; B60L 2240/70; B60L 2240/60

(57) ABSTRACT

A maintenance time acquisition unit acquires a periodic inspection and maintenance time determined in advance for each of a plurality of electric vehicles, a battery remaining life prediction unit predicts a remaining life of each of storage batteries from a state of the storage battery of each of the plurality of electric vehicles, and an operation plan creation unit creates an operation plan of the plurality of electric vehicles based on the periodic inspection and maintenance time of each of the plurality of electric vehicles and the remaining life of the storage battery of each of the plurality of electric vehicles.

### TECHNICAL FIELD

The present disclosure relates to a technique for managing operation of a plurality of electric vehicles.

### BACKGROUND ART

The storage battery mounted on the electric vehicle has a life. The storage battery whose life has ended needs to be replaced. However, for example, for a company that operates a plurality of electric vehicles such as a transportation company, in a case where battery replacement of a plurality of electric vehicles occurs simultaneously, a work cost required for the replacement and a loss due to being incapable of operating the electric vehicles during the replacement occur.

For example, Patent Literature 1 discloses that a management center of a vehicle control system calculates a battery life variable indicating a degree of deterioration of a secondary battery for each of a plurality of traveling paths based on data received from a vehicle, and sets a plurality of operation patterns in which the number of operation days for each traveling path is set so that the life is dispersed based on the battery life variable. Due to this, in Patent Literature 1, the lives of the secondary batteries of a plurality of vehicles are dispersed.

However, in the conventional technique, it is difficult to reduce the loss caused by halting the operation of the electric vehicle, and further improvement is required.

### CITATION LIST

### Patent Literature

Patent Literature 1: Japanese Patent No. 5186287

### SUMMARY OF INVENTION

The present disclosure has been made to solve the above problem, and an object is to provide a technique capable of reducing a loss caused by halting operation of an electric vehicle.

A vehicle operation management method according to the present disclosure includes, by a computer: acquiring a periodic inspection and maintenance time determined in advance for each of a plurality of electric vehicles; predicting a remaining life of each battery from a state of the battery of each of the plurality of electric vehicles; and creating an operation plan of the plurality of electric vehicles based on the periodic inspection and maintenance time of each of the plurality of electric vehicles and the remaining life of each of the plurality of electric vehicles.

According to the present disclosure, it is possible to reduce the loss generated by halting the operation of an electric vehicle.

### BRIEF DESCRIPTION OF DRAWINGS

FIG. 1 is a view illustrating an overall configuration of a vehicle management system in an embodiment of the present disclosure.

FIG. 2 is a view illustrating an example of a configuration of an electric vehicle in an embodiment of the present disclosure.

FIG. 3 is a view illustrating an example of a configuration of a server in an embodiment of the present disclosure.

FIG. 4 is a view for describing remaining life prediction processing of a storage battery by a battery remaining life prediction unit in the present embodiment.

FIG. 5 is a schematic view for describing a relationship between a battery remaining life ratio and a predicted replacement time in the present embodiment.

FIG. 6 is a flowchart for describing a vehicle operation management processing of the server in the embodiment of the present disclosure.

FIG. 7 is a schematic view for describing route assignment processing by a route assignment unit in the present embodiment.

FIG. 8 is a schematic view for describing route assignment processing by a route assignment unit in a first modification of the present embodiment.

FIG. 9 is a schematic view for describing route assignment processing by a route assignment unit in a second modification of the present embodiment.

### DESCRIPTION OF EMBODIMENTS

(Knowledge Underlying Present Disclosure)

A periodic inspection and maintenance time is predetermined for the electric vehicle. In the above-described conventional technique, the replacement time of the secondary battery and the cost required for replacement of the secondary battery are dispersed. However, in the conventional technique, the periodic inspection and maintenance time of the vehicle is not taken into consideration, and therefore there is a risk of deviation occurring between a battery replacement time and the periodic inspection and maintenance time. If the battery replacement time deviates from the periodic inspection and maintenance time, a period in which the operation is halted for the battery replacement and a period in which the operation is halted for the periodic inspection and maintenance are required. For this reason, there has conventionally been a risk of occurrences of a work cost required for these two halt periods and an operating loss due to being incapable of operation.

In order to solve the above problems, a vehicle operation management method according to an aspect of the present disclosure includes, by a computer: acquiring a periodic inspection and maintenance time determined in advance for each of a plurality of electric vehicles; predicting a remaining life of each battery from a state of the battery of each of the plurality of electric vehicles; and creating an operation plan of the plurality of electric vehicles based on the periodic inspection and maintenance time of each of the plurality of electric vehicles and the remaining life of each of the plurality of electric vehicles.

According to this configuration, it is possible to create an operation plan of a plurality of electric vehicles so that the period from the present to the periodic inspection and maintenance time of the electric vehicle coincides with the remaining life of the battery. This makes it possible to also replace the battery in the periodic inspection and maintenance. Therefore, it is possible to reduce the number of times of halting the operation of the electric vehicle for periodic inspection and maintenance or battery replacement, and it is possible to reduce the loss caused by halting the operation of the electric vehicle.

In the vehicle operation management method, in creating the operation plan, the operation plan of the plurality of electric vehicles may be created such that an electric vehicle having a remaining life that is longer compared with a period from present to the periodic inspection and maintenance time has a longer operation distance, and an electric vehicle having a remaining life that is shorter compared with a period from present to the periodic inspection and maintenance time has a shorter operation distance.

According to this configuration, since an electric vehicle having a remaining life of the battery that is longer than the period from the present to the periodic inspection and maintenance time operates for a long distance, deterioration of the battery progresses, and the replacement time of the battery can be brought close to the periodic inspection and maintenance time. Since an electric vehicle having a remaining life of the battery that is shorter than the period from the present to the periodic inspection and maintenance time operates for a short distance, deterioration of the battery is suppressed, and the replacement time of the battery can be brought close to the periodic inspection and maintenance time.

In the above vehicle operation management method, in creating the operation plan, a remaining life ratio may be calculated by dividing the remaining life by a period from present to the periodic inspection and maintenance time, and an operation plan of the plurality of electric vehicles may be created such that an electric vehicle having the remaining life ratio that is larger has a longer operation distance and an electric vehicle having the remaining life ratio that is smaller has a shorter operation distance.

According to this configuration, since an electric vehicle having a larger remaining life ratio in which the remaining life of the battery is divided by the period from the present to the periodic inspection and maintenance time operates for a long distance, deterioration of the battery progresses, and the replacement time of the battery can be brought close to the periodic inspection and maintenance time. Since an electric vehicle having a smaller remaining life ratio in which the remaining life of the battery is divided by the period from the present to the periodic inspection and maintenance time operates for a short distance, deterioration of the battery is suppressed, and the replacement time of the battery can be brought close to the periodic inspection and maintenance time.

In the above vehicle operation management method, in creating the operation plan, a plurality of operation routes determined in advance may be assigned to the plurality of electric vehicles.

According to this configuration, since a plurality of operation routes determined in advance are assigned to a plurality of electric vehicles, the operation route of each of the plurality of electric vehicles can be easily determined, and an operation plan can be easily created.

In the above vehicle operation management method, in creating the operation plan, an operation route having a shortest operation distance may be assigned to the electric vehicle having the remaining life ratio that is smallest.

According to this configuration, since the electric vehicle having the smallest remaining life ratio operates for the shortest distance, deterioration of the battery is further suppressed, and the replacement time of the battery can be reliably brought close to the periodic inspection and maintenance time.

In the vehicle operation management method, in creating the operation plan, at least one operation route in ascending order from the shortest operation distance among the plurality of operation routes may be assigned to at least one electric vehicle having the remaining life ratio that is equal to or less than a predetermined value among the plurality of electric vehicles.

According to this configuration, by suppressing the operation of at least one electric vehicle having the remaining life ratio that is equal to or less than a predetermined value, it is possible to extend the remaining life of the battery of the at least one electric vehicle, and it is possible to bring the replacement time of the battery of the at least one electric vehicle close to the periodic inspection and maintenance time.

In the above vehicle operation management method, in creating the operation plan, a predetermined number of operation routes arranged in order from an operation route having a shortest operation distance among the plurality of operation routes may be assigned to a predetermined number of electric vehicles arranged in order from an electric vehicle having the remaining life ratio that is smallest among the plurality of electric vehicles.

According to this configuration, by suppressing the operation of a predetermined number of electric vehicles arranged in order from the electric vehicle having the smallest remaining life ratio among the plurality of electric vehicles, it is possible to extend the remaining life of the batteries of a predetermined number of electric vehicles, and it is possible to bring the replacement time of the batteries of the predetermined number of electric vehicles close to the periodic inspection and maintenance time.

In the above vehicle operation management method, in creating the operation plan, the plurality of electric vehicles may be arranged in ascending order of the remaining life ratio, the plurality of operation routes may be arranged in ascending order of operation distance, and the plurality of operation routes arranged in ascending order may be assigned respectively to the plurality of electric vehicles arranged in ascending order.

According to this configuration, since the plurality of operation routes arranged in ascending order of operation distance are assigned respectively to the plurality of electric vehicles arranged in ascending order of remaining life ratio, the replacement time of the battery of each of the plurality of electric vehicles can be brought close to the periodic inspection and maintenance time of each of the plurality of electric vehicles.

In the above vehicle operation management method, in creating the operation plan, when a plurality of periodic inspection and maintenance times are acquired for one electric vehicle, the periodic inspection and maintenance time that is closest to a predicted replacement time until the remaining life elapses from present may be selected from among the plurality of periodic inspection and maintenance times.

According to this configuration, when a plurality of periodic inspection and maintenance times are acquired for one electric vehicle, the periodic inspection and maintenance time that is closest to a predicted replacement time until the remaining life of the battery elapses from the present is selected from among the plurality of periodic inspection and maintenance times. Therefore, since the operation plan of the plurality of electric vehicles is created so that the period from the present to the periodic inspection and maintenance time that is closest to the predicted replacement time coincides with the remaining life of the battery, the replacement time of the battery can be reliably brought close to the periodic inspection and maintenance time.

A vehicle operation management device according to another aspect of the present disclosure includes an acquisition unit that acquires a periodic inspection and maintenance time determined in advance for each of a plurality of electric vehicles, a prediction unit that predicts a remaining life of each battery from a state of the battery of each of the plurality of electric vehicles, and a creation unit that creates an operation plan of the plurality of electric vehicles based on the periodic inspection and maintenance time of each of the plurality of electric vehicles and the remaining life of each of the plurality of electric vehicles.

According to this configuration, it is possible to create an operation plan of a plurality of electric vehicles so that the period from the present to the periodic inspection and maintenance time of the electric vehicle coincides with the remaining life of the battery. This makes it possible to also replace the battery in the periodic inspection and maintenance. Therefore, it is possible to reduce the number of times of halting the operation of the electric vehicle for periodic inspection and maintenance or battery replacement, and it is possible to reduce the loss caused by halting the operation of the electric vehicle.

A non-transitory computer readable recording medium storing a vehicle operation management program according to another aspect of the present disclosure causes a computer to function to: acquire a periodic inspection and maintenance time determined in advance for each of a plurality of electric vehicles; predict a remaining life of each battery from a state of the battery of each of the plurality of electric vehicles; and create an operation plan of the plurality of electric vehicles based on the periodic inspection and maintenance time of each of the plurality of electric vehicles and the remaining life of each of the plurality of electric vehicles.

According to this configuration, it is possible to create an operation plan of a plurality of electric vehicles so that the period from the present to the periodic inspection and maintenance time of the electric vehicle coincides with the remaining life of the battery. This makes it possible to also replace the battery in the periodic inspection and maintenance. Therefore, it is possible to reduce the number of times of halting the operation of the electric vehicle for periodic inspection and maintenance or battery replacement, and it is possible to reduce the loss caused by halting the operation of the electric vehicle.

An embodiment of the present disclosure will be described below with reference to the accompanying drawings. The following embodiment is an example in which the present disclosure is embodied, and is not intended to limit the technical scope of the present disclosure.

### Embodiment

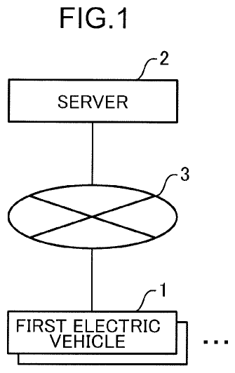

FIG. 1 is a view illustrating an overall configuration of a vehicle management system in an embodiment of the present disclosure.

The vehicle management system illustrated in FIG. 1 includes a plurality of electric vehicles 1 and a server 2.

The electric vehicle 1 is an example of equipment that operates using a mounted battery. The electric vehicle 1 is, for example, an electric car, an electric truck, an electric bus, or an electric motorcycle, and moves by supplying electric power charged in a battery to an electric motor. For example, the plurality of electric vehicles 1 are operated by a transportation company. The basic configuration of each of the plurality of electric vehicles 1 is the same.

In the electric vehicle 1, a periodic inspection and maintenance time is determined in advance. The periodic inspection and maintenance is an inspection and maintenance performed at predetermined intervals, and is performed at a maintenance factory certified by the central government or the like, for example. For example, in a case of trucks for transportation business, inspection of 47 items is performed every three months, and inspection of 96 items is performed every year. The interval at which inspections are performed and the number of items may be defined by law or may be different for each country. The periodic inspection and maintenance is performed over one day to several days, and the electric vehicle 1 cannot be used during the periodic inspection and maintenance.

The electric vehicle 1 is communicably connected to the server 2 via a network 3. The network 3 is, for example, the Internet.

The electric vehicle 1 transmits, to the server 2, battery information indicating a state of a battery mounted on the electric vehicle 1. The battery information is a state of health (SOH) estimated based on the operation data of the battery, for example.

The server 2 is, for example, a Web server. The server 2 receives various types of information from the plurality of electric vehicles 1. Based on the state of the battery received from each of the plurality of electric vehicles 1, the server 2 predicts the remaining life of the battery mounted on each of the plurality of electric vehicles 1. The server 2 creates an operation plan of the plurality of electric vehicles 1.

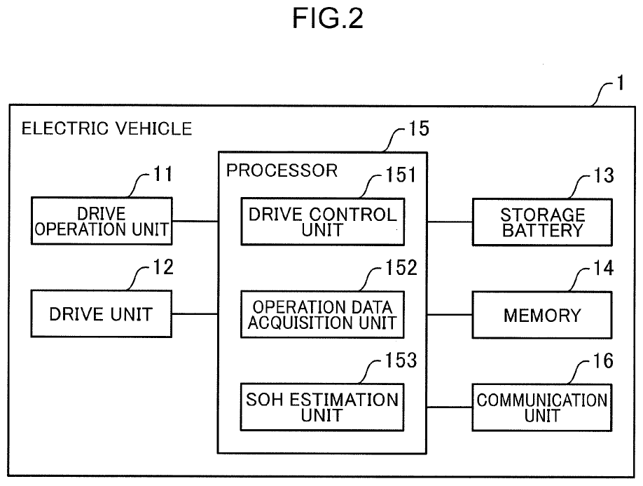

FIG. 2 is a view illustrating an example of the configuration of the electric vehicle 1 in an embodiment of the present disclosure.

The electric vehicle 1 illustrated in FIG. 2 includes a drive operation unit 11, a drive unit 12, a storage battery 13, a memory 14, a processor 15, and a communication unit 16.

The drive operation unit 11 receives a drive operation of the electric vehicle 1 by the driver. The drive operation unit 11 includes, for example, a steering wheel, a shift lever, an accelerator pedal, and a brake pedal. Note that the electric vehicle 1 may be an autonomous car. In a case where the electric vehicle 1 is an autonomous car, an autonomous system controls drive instead of the drive operation unit 11.

The drive unit 12 is, for example, an inverter, an electric motor, and a transmission, and moves the electric vehicle 1 under the control of a drive control unit 151.

The storage battery 13 is, for example, a nickel-metal hydride battery or a lithium ion secondary battery, stores electric power by charging, and supplies electric power to the drive unit 12 by discharging. The storage battery 13 is an example of battery.

The memory 14 is a storage device capable of storing various types of information, such as a random access memory (RAM), a solid state drive (SSD), or a flash memory. The memory 14 stores an operation history of the storage battery 13.

The processor 15 is, for example, a central processing unit (CPU). The processor 15 implements the drive control unit 151, an operation data acquisition unit 152, and an SOH estimation unit 153.

The drive control unit 151 controls the drive unit 12 in response to a drive operation of the driver by the drive operation unit 11 to move the electric vehicle 1.

The operation data acquisition unit 152 acquires operation data of the storage battery 13. The operation data includes, for example, a state of charge (SOC), temperature, and a current value of the storage battery 13. The SOC is an index representing a charging rate of the storage battery 13. The SOC of the storage battery 13 is represented by (remaining capacity [Ah]/full charge capacity [Ah])*100. The temperature of the storage battery 13 is measured by a temperature sensor (not illustrated) provided in the storage battery 13. The current value of the storage battery 13 is measured by a measuring instrument (not illustrated) provided in the storage battery 13. The operation data acquisition unit 152 outputs operation data including the SOC, the temperature, and the current value of the storage battery 13 to the SOH estimation unit 153.

The SOH estimation unit 153 estimates the SOH based on the operation data of the storage battery 13 acquired by the operation data acquisition unit 152. The SOH is an index indicating the health of the storage battery 13. The SOH of the storage battery 13 is represented by (full charge capacity [Ah] at the time of deterioration (present)/initial full charge capacity [Ah])*100. Note that the SOH estimation method is a conventional technique, and thus description is omitted. The SOH estimation unit 153 outputs the estimated SOH to the communication unit 16.

Note that in the present embodiment, the SOC, the temperature, and the current value are used to estimate the SOH of the storage battery 13, but the present disclosure is not particularly limited to this, and the SOH estimation unit 153 is only required to acquire operation data necessary for estimating the SOH of the storage battery 13.

The communication unit 16 transmits, to the server 2, the battery information including the SOH estimated by the SOH estimation unit 153. The communication unit 16 periodically transmits the battery information including the SOH to the server 2. The communication unit 16 transmits the battery information to the server 2 every 10 minutes, for example.

Note that in the present embodiment, since the SOH is used to predict the remaining life of the storage battery 13, the SOH is transmitted to the server 2. However, the present disclosure is not particularly limited to this, and a parameter necessary for predicting the remaining life of the storage battery 13 is only required to be transmitted to the server 2.

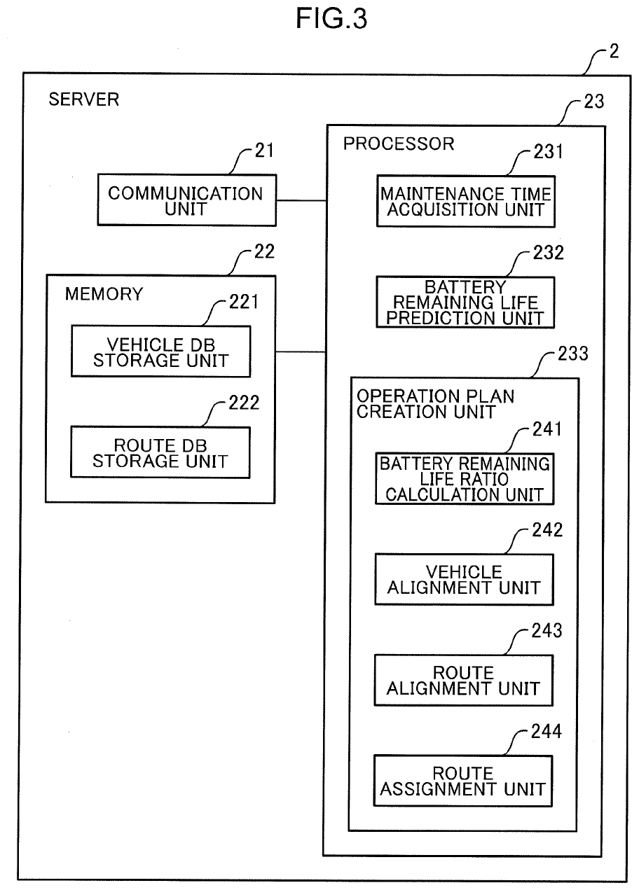

FIG. 3 is a view illustrating an example of the configuration of the server 2 in an embodiment of the present disclosure.

The server 2 illustrated in FIG. 3 includes a communication unit 21, a memory 22, and a processor 23.

The communication unit 21 receives the battery information transmitted by each of the plurality of electric vehicles 1. The battery information indicates the state of the storage battery 13 mounted on the electric vehicle 1, and is the SOH, for example. The communication unit 21 stores the received battery information in a vehicle DB storage unit 221 in association with a vehicle ID.

The memory 22 is a storage device capable of storing various types of information, such as a RAM, a hard disk drive (HDD), an SSD, or a flash memory. The memory 22 implements a vehicle database (DB) storage unit 221 and a route database (DB) storage unit 222.

The vehicle DB storage unit 221 stores a vehicle DB in which the vehicle ID for identifying the electric vehicle 1, the battery information of the electric vehicle 1, and the periodic inspection and maintenance time of the electric vehicle 1 are associated with one another. The battery information is the SOH of the storage battery 13 mounted on the electric vehicle 1. The vehicle DB storage unit 221 may store only the latest SOH or may store a history of the SOH. The vehicle DB storage unit 221 may store the vehicle DB for each company that manages the plurality of electric vehicles 1. The vehicle DB storage unit 221 may store a vehicle DB in which the company ID for identifying the company that manages the plurality of electric vehicles 1, the vehicle ID, the battery information, and the periodic inspection and maintenance time are associated with one another.

The route DB storage unit 222 stores a plurality of operation routes assigned to each of the plurality of electric vehicles 1. The route DB storage unit 222 stores a route DB in which the route ID for identifying the operation route, the operation route, and the operation distance are associated with one another. The plurality of operation routes are determined in advance and input by a terminal not illustrated. The operation route represents a point through which the electric vehicle 1 passes, such as a delivery destination and/or a pickup destination, for example. The route DB storage unit 222 may store the route DB for each company that manages the plurality of electric vehicles 1. The route DB storage unit 222 may store a route DB in which the company ID for identifying the company that manages the plurality of electric vehicles 1, the route ID, the operation route, and the operation distance are associated with one another.

The processor 23 is, for example, a CPU. The processor 23 implements a maintenance time acquisition unit 231, a battery remaining life prediction unit 232, and an operation plan creation unit 233.

The maintenance time acquisition unit 231 acquires a periodic inspection and maintenance time determined in advance for each of the plurality of electric vehicles 1. The maintenance time acquisition unit 231 reads the periodic inspection and maintenance time of each of the plurality of electric vehicles 1 from the vehicle DB storage unit 221.

The battery remaining life prediction unit 232 predicts the remaining life of each of the storage batteries 13 from the state of the storage battery 13 of each of the plurality of electric vehicles 1. The battery remaining life prediction unit 232 predicts the remaining life of each of the storage batteries 13 from the SOH of the storage battery 13 of each of the plurality of electric vehicles 1.

Here, in the present embodiment, remaining life prediction processing of the storage battery 13 by the battery remaining life prediction unit 232 will be described.

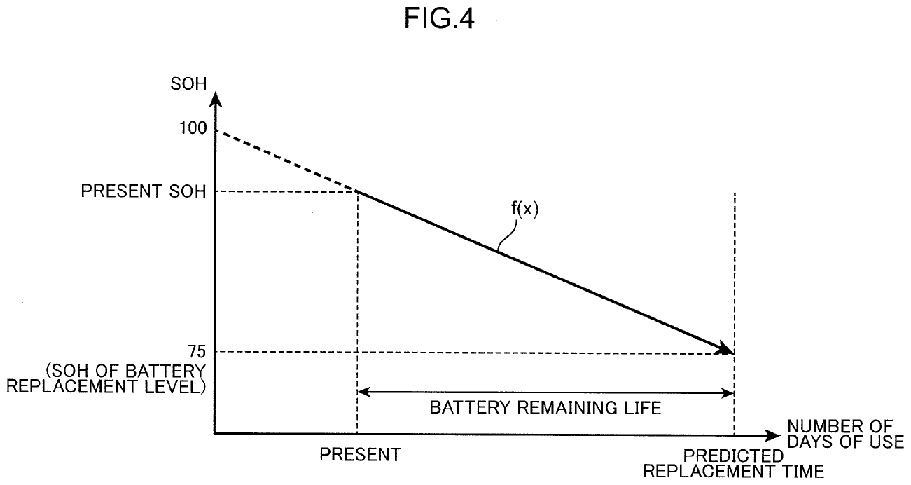

FIG. 4 is a view for describing the remaining life prediction processing of the storage battery 13 by the battery remaining life prediction unit 232 in the present embodiment. In FIG. 4, the vertical axis represents the SOH, and the horizontal axis represents the number of days of use of the storage battery 13.

The SOH at the start of use of the storage battery 13 is 100. As the number of days of use elapses and charging and discharging of the storage battery 13 are repeated, the SOH decreases. The SOH decreases as the number of days of use increases. The memory 22 stores in advance a function f(x) indicating a relationship between the number of days of use and the SOH. The function f(x) is a linear function as illustrated in FIG. 4. The SOH of the battery replacement level is, for example, 75. The number of days of use when the SOH is 75 is the predicted replacement time.

The battery remaining life prediction unit 232 calculates the predicted replacement time based on the function f(x) and the SOH of the battery replacement level. The battery remaining life prediction unit 232 calculates the present number of days of use by substituting the present SOH into the function f(x). The battery remaining life prediction unit 232 calculates the battery remaining life by subtracting the present number of days of use from the predicted replacement time.

Note that the function f(x) may be fixed. Since the deterioration degree of the storage battery 13 changes in accordance with the usage of the storage battery 13, the function f(x) may be corrected in accordance with the usage of the storage battery 13. That is, the memory 22 may store the start date of use of the storage battery 13 in advance. By storing the start date of use of the storage battery 13 in advance, the number of days of use from the start date of use to the present can be calculated. The battery remaining life prediction unit 232 may correct the slope of the linear function f(x) based on the number of days of use from the start date of use to the present and a value (100) of the SOH at the start of use.

The operation plan creation unit 233 creates an operation plan of the plurality of electric vehicles 1 based on the periodic inspection and maintenance time of each of the plurality of electric vehicles 1 and the remaining life of the storage battery 13 of each of the plurality of electric vehicles 1. The operation plan creation unit 233 creates an operation plan of the plurality of electric vehicles 1 such that the electric vehicle 1 having a remaining life of the storage battery 13 that is longer compared with a period from present to the periodic inspection and maintenance time has a longer operation distance, and the electric vehicle 1 having a remaining life of the storage battery 13 that is shorter compared with a period from present to the periodic inspection and maintenance time has a shorter operation distance.

The operation plan creation unit 233 calculates the battery remaining life ratio in which the remaining life of the storage battery 13 predicted by the battery remaining life prediction unit 232 is divided by the period from the present to the periodic inspection and maintenance time, and creates an operation plan of the plurality of electric vehicles 1 such that the electric vehicle 1 having a larger battery remaining life ratio has a longer operation distance and the electric vehicle 1 having a smaller battery remaining life ratio has a shorter operation distance.

The operation plan creation unit 233 includes a battery remaining life ratio calculation unit 241, a vehicle alignment unit 242, a route alignment unit 243, and a route assignment unit 244.

The battery remaining life ratio calculation unit 241 calculates the battery remaining life ratio in which the remaining life of the storage battery 13 predicted by the battery remaining life prediction unit 232 is divided by the period from the present to the periodic inspection and maintenance time.

The vehicle alignment unit 242 arranges the plurality of electric vehicles 1 in ascending order of battery remaining life ratio.

The route alignment unit 243 arranges the plurality of operation routes in ascending order of operation distance.

The route assignment unit 244 assigns a plurality of operation routes determined in advance to the plurality of electric vehicles 1. The route assignment unit 244 assigns an operation route having the shortest operation distance to the electric vehicle 1 having the smallest battery remaining life ratio. The route assignment unit 244 assigns, respectively to the plurality of electric vehicles 1 arranged in ascending order of battery remaining life ratio by the vehicle alignment unit 242, the plurality of operation routes arranged in ascending order of operation distance by the route alignment unit 243.

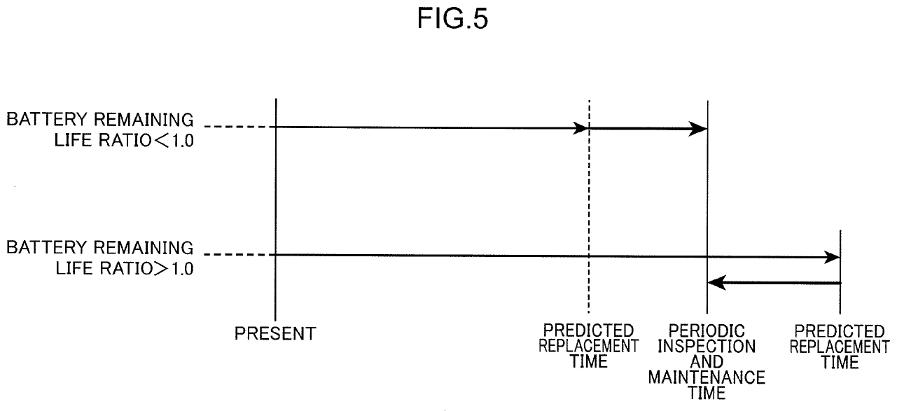

FIG. 5 is a schematic view for describing the relationship between the battery remaining life ratio and the predicted replacement time in the present embodiment.

As illustrated in FIG. 5, when the battery remaining life ratio is smaller than 1.0, the predicted replacement time of the storage battery 13 becomes earlier than the periodic inspection and maintenance time. In this case, in order to make the replacement time of the storage battery 13 and the periodic inspection and maintenance time the same, it is necessary to suppress use of the storage battery 13 as much as possible. Therefore, the electric vehicle 1 having a battery remaining life ratio that is smaller than 1.0 is assigned with an operation route with an operation distance as short as possible. Due to this, deterioration of the storage battery 13 is suppressed, the replacement time of the storage battery 13 can be brought close to the periodic inspection and maintenance time, and the replacement time of the storage battery 13 and the periodic inspection and maintenance time can be made the same.

On the other hand, as illustrated in FIG. 5, when the battery remaining life ratio is larger than 1.0, the predicted replacement time of the storage battery 13 becomes later than the periodic inspection and maintenance time. In this case, in order to make the replacement time of the storage battery 13 and the periodic inspection and maintenance time the same, it is necessary to use the storage battery 13 as much as possible. Therefore, the electric vehicle 1 having a battery remaining life ratio that is larger than 1.0 is assigned with an operation route with an operation distance as long as possible. Due to this, deterioration of the storage battery 13 progresses, the replacement time of the storage battery 13 can be brought close to the periodic inspection and maintenance time, and the replacement time of the storage battery 13 and the periodic inspection and maintenance time can be made the same.

Subsequently, vehicle operation management processing of the server 2 in an embodiment of the present disclosure will be described.

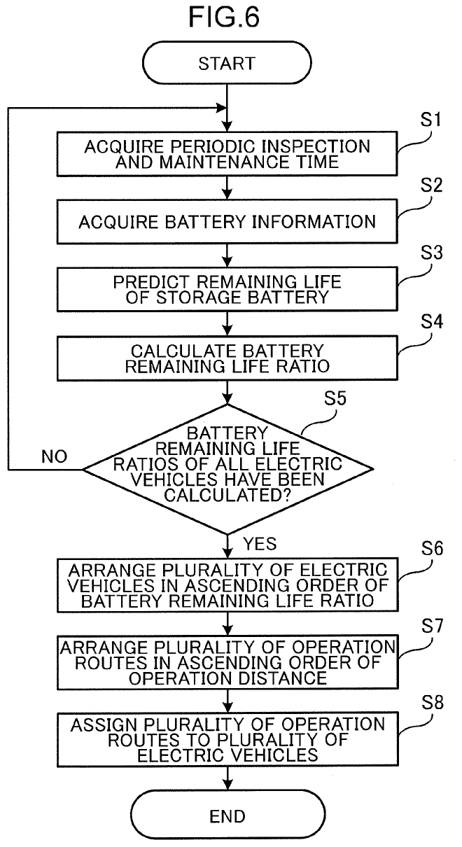

FIG. 6 is a flowchart for describing the vehicle operation management processing of the server 2 in an embodiment of the present disclosure.

Note that the vehicle operation management processing may be performed, for example, every morning when an operation plan for the day is created. The vehicle operation management processing may be performed, for example, every night when an operation plan for the next day is created. The vehicle operation management processing may be performed, for example, once a week when an operation plan for one week is created.

First, in step S1, the maintenance time acquisition unit 231 acquires, from the vehicle DB storage unit 221, a periodic inspection and maintenance time determined in advance for one electric vehicle 1 among the plurality of electric vehicles 1 for which the operation plan is created.

Next, in step S2, the battery remaining life prediction unit 232 acquires, from the vehicle DB storage unit 221, the battery information of the one electric vehicle 1 among the plurality of electric vehicles 1. At this time, the battery remaining life prediction unit 232 reads the latest SOH of the one electric vehicle 1 from the vehicle DB storage unit 221.

Next, in step S3, the battery remaining life prediction unit 232 predicts the remaining life of the storage battery 13 mounted on the one electric vehicle 1 from the battery information of the one electric vehicle 1. At this time, the battery remaining life prediction unit 232 predicts the remaining life of the storage battery 13 from the SOH of the one electric vehicle 1 read from the vehicle DB storage unit 221.

Next, in step S4, the battery remaining life ratio calculation unit 241 calculates the battery remaining life ratio of the one electric vehicle 1. At this time, the battery remaining life ratio calculation unit 241 calculates the battery remaining life ratio by dividing the remaining life of the storage battery 13 of the one electric vehicle 1 predicted by the battery remaining life prediction unit 232 by the period from the present to the periodic inspection and maintenance time of the one electric vehicle 1. Note that the remaining life of the storage battery 13 and the period from the present to the periodic inspection and maintenance time are represented by the number of days, for example.

Next, in step S5, the battery remaining life ratio calculation unit 241 determines whether or not the battery remaining life ratios of all the electric vehicles 1 among the plurality of electric vehicles 1 have been calculated. Here, when it is determined that the battery remaining life ratios of all the electric vehicles 1 have not been calculated (NO in step S5), the processing returns to step S1. In step S1, the maintenance time acquisition unit 231 acquires, from the vehicle DB storage unit 221, a periodic inspection and maintenance time determined in advance for another electric vehicle 1 for which the battery remaining life ratio has not been calculated among the plurality of electric vehicles 1. Then, the processing of steps S1 to S5 is repeated until the battery remaining life ratios of all the electric vehicles 1 among the plurality of electric vehicles 1 are calculated.

On the other hand, when it is determined that the battery remaining life ratios of all the electric vehicles 1 have been calculated (YES in step S5), the vehicle alignment unit 242 arranges in step S6 the plurality of electric vehicles 1 in ascending order of the battery remaining life ratio calculated by the battery remaining life ratio calculation unit 241.

Next, in step S7, the route alignment unit 243 arranges the plurality of operation routes in ascending order of operation distance.

Next, in step S8, the route assignment unit 244 assigns, respectively to the plurality of electric vehicles 1 arranged in ascending order of battery remaining life ratio by the vehicle alignment unit 242, the plurality of operation routes arranged in ascending order of operation distance by the route alignment unit 243.

Due to this, an operation plan indicating which operation route each of the plurality of electric vehicles 1 travels is created.

Thus, the server 2 can create an operation plan for the plurality of electric vehicles 1 such that the period from the present to the periodic inspection and maintenance time of the electric vehicle 1 coincides with the remaining life of the storage battery. This makes it possible to also replace the storage battery in the periodic inspection and maintenance. Therefore, it is possible to reduce the number of times of halting the operation of the electric vehicle 1 for periodic inspection and maintenance or battery replacement, and it is possible to reduce the loss caused by halting the operation of the electric vehicle 1.

Here, route assignment processing of assigning a plurality of operation routes to the plurality of electric vehicles 1 will be described.

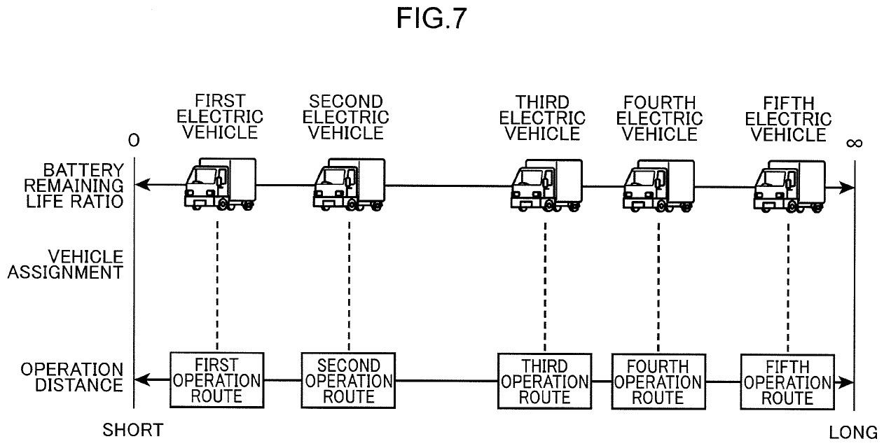

FIG. 7 is a schematic view for describing the route assignment processing by the route assignment unit 244 in the present embodiment.

As illustrated in FIG. 7, a first electric vehicle, a second electric vehicle, a third electric vehicle, a fourth electric vehicle, and a fifth electric vehicle are arranged in ascending order of battery remaining life ratio, and a first operation route, a second operation route, a third operation route, a fourth operation route, and a fifth operation route are arranged in ascending order of operation distance. The first electric vehicle having the smallest battery remaining life ratio is assigned with the first operation route having the shortest operation distance. The second electric vehicle having the second smallest battery remaining life ratio is assigned with the second operation route having the second shortest operation distance. The third electric vehicle having the third smallest battery remaining life ratio is assigned with the third operation route having the third shortest operation distance. The fourth electric vehicle having the fourth smallest battery remaining life ratio is assigned with the fourth operation route having the fourth shortest operation distance. The fifth electric vehicle having the largest battery remaining life ratio is assigned with the fifth operation route having the longest operation distance.

Thus, the route assignment unit 244 assigns, respectively to the plurality of electric vehicles 1 arranged in ascending order of battery remaining life ratio by the vehicle alignment unit 242, the plurality of operation routes arranged in ascending order of operation distance by the route alignment unit 243.

Note that the communication unit 21 may transmit the operation plan created by the operation plan creation unit 233 to a terminal of the company that manages the plurality of electric vehicles 1. The terminal may receive the operation plan and display the received operation plan.

In the present embodiment, the vehicle DB storage unit 221 stores the latest one periodic inspection and maintenance time in association with one electric vehicle 1. However, the present disclosure is not particularly limited to this, and a plurality of periodic inspection and maintenance times may be stored in association with one electric vehicle 1. For example, in a case where the periodic inspection and maintenance is performed on Sep. 1, 2020, the periodic inspection performed every year is performed on Sep. 1, 2021, Sep. 1, 2022, and Sep. 1, 2023. The remaining life of the storage battery 13 is also not limited to one year, and may be three years. In a case where the remaining life of the storage battery 13 is predicted to be three years on Oct. 1, 2020, the predicted replacement time can be brought closer to the periodic inspection and maintenance time more reliably and easily by calculating the battery remaining life ratio using the periodic inspection and maintenance time (Sep. 1, 2023) closest to the predicted replacement time (Oct. 1, 2023) than by calculating the battery remaining life ratio using the periodic inspection and maintenance time (Sep. 1, 2021) closest to the time point of prediction (Oct. 1, 2020).

Therefore, when a plurality of periodic inspection and maintenance times are acquired for one electric vehicle 1, the battery remaining life ratio calculation unit 241 may select, from among the plurality of periodic inspection and maintenance times, periodic inspection and maintenance time closest to the time point (predicted replacement time) at which the remaining life of the storage battery 13 has elapsed from the present. The battery remaining life ratio calculation unit 241 may then calculate the battery remaining life ratio in which the remaining life of the storage battery 13 predicted by the battery remaining life prediction unit 232 is divided by the period from the present to the selected periodic inspection and maintenance time.

In the present embodiment, the route assignment unit 244 assigns the plurality of operation routes arranged in ascending order of operation distance respectively to the plurality of electric vehicles 1 arranged in ascending order of battery remaining life ratio. However, the present disclosure is not particularly limited to this. The route assignment unit 244 may assign an operation route having the shortest operation distance only to the electric vehicle 1 having the smallest battery remaining life ratio. In this case, the route assignment unit 244 may assign the operation route using another condition other than the operation distance for the electric vehicles other than the electric vehicle 1 having the smallest battery remaining life ratio. The other condition is, for example, the loading amount of the electric vehicle 1 or the like.

The upper limit value of the loading amount of the electric vehicle is determined in advance. Therefore, in a case where the total loading amount of the cargo scheduled to be picked up in a certain operation route exceeds the upper limit value of the loading amount of the electric vehicle, the electric vehicle cannot pick up all the cargoes. Therefore, the route assignment unit 244 may determine the operation route of an electric vehicle other than the electric vehicle having the smallest battery remaining life ratio among the plurality of electric vehicles in consideration of the loading amount of the electric vehicle in each of the plurality of operation routes.

That is, the route assignment unit 244 may assign the operation route to an electric vehicle other than the electric vehicle 1 having the smallest battery remaining life ratio among the plurality of electric vehicles based on the loading amount of the electric vehicle in each of the plurality of operation routes. The vehicle DB storage unit 221 may store a vehicle DB in which the company ID, the vehicle ID, the battery information, the periodic inspection and maintenance time, and the upper limit value of the loading amount that can be loaded by the electric vehicle 1 are associated with one another. The loading amount is the weight of the loading target, for example. The route DB storage unit 222 may store a route DB in which the route ID, the operation route, the operation distance, and the loading amount of a cargo or a person scheduled in the operation route are associated with one another. The route assignment unit 244 may acquire the upper limit value of the loading amount of another electric vehicle other than the electric vehicle 1 having the smallest battery remaining life ratio and the loading amount scheduled in each operation route. Then, the route assignment unit 244 may assign the operation route to the other electric vehicle so that the loading amount scheduled in each operation route does not exceed the upper limit value of the loading amount of the other electric vehicle.

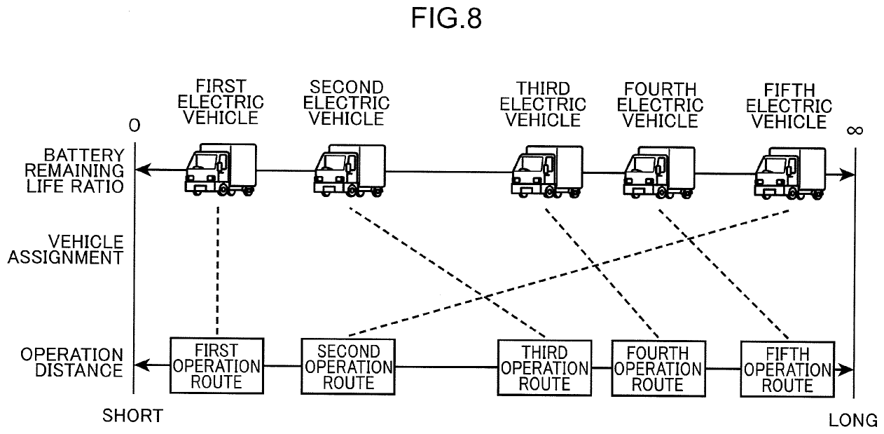

FIG. 8 is a schematic view for describing the route assignment processing by the route assignment unit 244 in a first modification of the present embodiment.

As illustrated in FIG. 8, the first electric vehicle, the second electric vehicle, the third electric vehicle, the fourth electric vehicle, and the fifth electric vehicle are arranged in ascending order of battery remaining life ratio, and the first operation route, the second operation route, the third operation route, the fourth operation route, and the fifth operation route are arranged in ascending order of operation distance. Only the first electric vehicle having the smallest battery remaining life ratio is assigned with the first operation route having the shortest operation distance.

The second electric vehicle having the second smallest battery remaining life ratio is assigned with the third operation route having the third shortest operation distance. The third electric vehicle having the third smallest battery remaining life ratio is assigned with the fourth operation route having the fourth shortest operation distance. The fourth electric vehicle having the fourth smallest battery remaining life ratio is assigned with the fifth operation route having the longest operation distance. Furthermore, the fifth electric vehicle having the largest battery remaining life ratio is assigned with the second operation route having the second shortest operation distance. For the second electric vehicle to the fifth electric vehicle, the operation routes are assigned regardless of the operation distance.

Thus, the route assignment unit 244 may assign the operation route having a shortest operation distance only to the electric vehicle 1 having the smallest battery remaining life ratio.

Due to this, the electric vehicles other than the electric vehicle 1 having the smallest battery remaining life ratio are assigned with operation routes other than the operation route having the shortest operation distance. Therefore, it is possible to more freely assign an operation route to an electric vehicle other than the electric vehicle 1 having the smallest battery remaining life ratio.

In the present embodiment, the route assignment unit 244 may assign at least one operation route in ascending order from the shortest operation distance among the plurality of operation routes to at least one electric vehicle 1 having a battery remaining life ratio that is equal to or less than a predetermined value among the plurality of electric vehicles 1. In this case, the route assignment unit 244 may assign the operation route using another condition other than the operation distance for the electric vehicle 1 having a battery remaining life ratio larger than the predetermined value. The other condition is, for example, the loading amount of the electric vehicle 1 or the like.

That is, based on the loading amount of the electric vehicle in each of the plurality of operation routes, the route assignment unit 244 may assign the operation route to another electric vehicle having a battery remaining life ratio larger than the predetermined value among the plurality of electric vehicles. The vehicle DB storage unit 221 may store a vehicle DB in which the company ID, the vehicle ID, the battery information, the periodic inspection and maintenance time, and the upper limit value of the loading amount that can be loaded by the electric vehicle 1 are associated with one another. The loading amount is the weight of the loading target, for example. The route DB storage unit 222 may store a route DB in which the route ID, the operation route, the operation distance, and the loading amount of a cargo or a person scheduled in the operation route are associated with one another. The route assignment unit 244 may acquire the upper limit value of the loading amount of the other electric vehicle having a battery remaining life ratio larger than the predetermined value and the loading amount scheduled in each operation route. Then, the route assignment unit 244 may assign the operation route to the other electric vehicle so that the loading amount scheduled in each operation route does not exceed the upper limit value of the loading amount of the other electric vehicle.

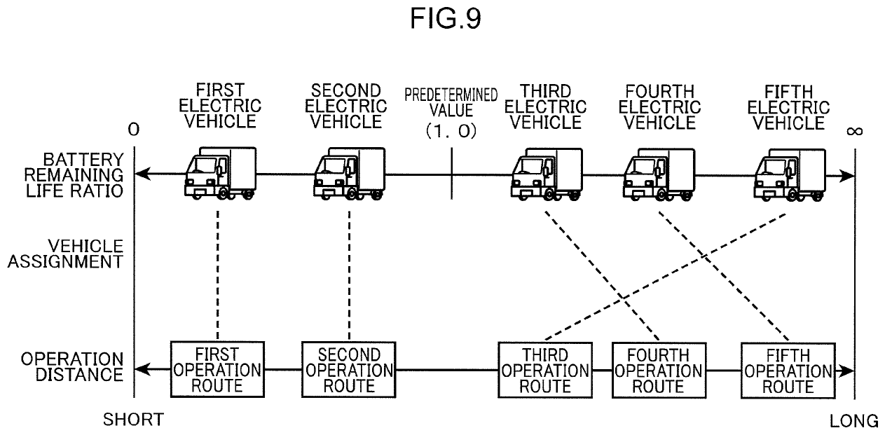

FIG. 9 is a schematic view for describing route assignment processing by a route assignment unit 244 in a second modification of the present embodiment.

As illustrated in FIG. 9, the first electric vehicle, the second electric vehicle, the third electric vehicle, the fourth electric vehicle, and the fifth electric vehicle are arranged in ascending order of battery remaining life ratio, and the first operation route, the second operation route, the third operation route, the fourth operation route, and the fifth operation route are arranged in ascending order of operation distance. Then, the first electric vehicle having a battery remaining life ratio that is equal to or less than the predetermined value is assigned with the first operation route having the shortest operation distance. The second electric vehicle having a battery remaining life ratio that is equal to or less than a predetermined value is assigned with the second operation route having the second shortest operation distance. The predetermined value is, for example, 1.0.

The third electric vehicle having the third smallest battery remaining life ratio is assigned with the fourth operation route having the fourth shortest operation distance. The fourth electric vehicle having the fourth smallest battery remaining life ratio is assigned with the fifth operation route having the longest operation distance. Furthermore, the fifth electric vehicle having the largest battery remaining life ratio is assigned with the third operation route having the third shortest operation distance. For the third electric vehicle to the fifth electric vehicle, the operation routes are assigned regardless of the operation distance.

Thus, the route assignment unit 244 may assign at least one operation route in ascending order from the shortest operation distance among the plurality of operation routes to at least one electric vehicle 1 having a battery remaining life ratio that is equal to or less than a predetermined value among the plurality of electric vehicles 1. Note that the predetermined value is not limited to 1.0. The predetermined value may be, for example, 0.5.

Due to this, for example, in a case where the battery remaining life ratio is equal to or less than 1.0, by suppressing the operation of the electric vehicle 1, it is possible to extend the remaining life of the storage battery 13, and it is possible to bring the replacement time of the storage battery 13 close to the periodic inspection and maintenance time. The electric vehicle 1 having a battery remaining life ratio that is larger than 1.0 is assigned with an operation route other than at least one operation route. Therefore, it is possible to more freely assign an operation route to the electric vehicle 1 having a battery remaining life ratio that is larger than the predetermined value.

In the present embodiment, the route assignment unit 244 may assign a predetermined number of operation routes arranged in order from an operation route having the shortest operation distance among the plurality of operation routes to a predetermined number of electric vehicles arranged in order from an electric vehicle having the smallest remaining life ratio among the plurality of electric vehicles. In this case, the route assignment unit 244 may assign the operation route using another condition other than the operation distance for the electric vehicles other than the predetermined number of electric vehicles among the plurality of electric vehicles. The other condition is, for example, the loading amount of the electric vehicle 1 or the like. For example, the route assignment unit 244 may assign three operation routes arranged in order from an operation route having the shortest operation distance among five operation routes to three electric vehicles arranged in order from an electric vehicle having the smallest battery remaining life ratio among five electric vehicles.

That is, the route assignment unit 244 may assign the operation route to other electric vehicles other than a predetermined number of electric vehicles among the plurality of electric vehicles based on the loading amount of the electric vehicle in each of the plurality of operation routes. The vehicle DB storage unit 221 may store a vehicle DB in which the company ID, the vehicle ID, the battery information, the periodic inspection and maintenance time, and the upper limit value of the loading amount that can be loaded by the electric vehicle 1 are associated with one another. The loading amount is the weight of the loading target, for example. The route DB storage unit 222 may store a route DB in which the route ID, the operation route, the operation distance, and the loading amount of a cargo or a person scheduled in the operation route are associated with one another. The route assignment unit 244 may acquire the upper limit value of the loading amount of another electric vehicle other than the predetermined number of electric vehicles and the loading amount scheduled in each operation route. Then, the route assignment unit 244 may assign the operation route to the other electric vehicle so that the loading amount scheduled in each operation route does not exceed the upper limit value of the loading amount of the other electric vehicle.

Thus, by suppressing the operation of a predetermined number of electric vehicles arranged in order from the electric vehicle having the smallest remaining life ratio among the plurality of electric vehicles, it is possible to extend the remaining life of the storage batteries 13 of a predetermined number of electric vehicles, and it is possible to bring the replacement time of the storage batteries 13 of the predetermined number of electric vehicles close to the periodic inspection and maintenance time. Among the plurality of electric vehicles, an electric vehicle other than the predetermined number of electric vehicles is assigned with an operation route other than the predetermined number of operation routes. Therefore, it is possible to more freely assign an operation route to an electric vehicle other than a predetermined number of electric vehicles arranged in order from an electric vehicle having the smallest remaining life ratio.

Note that in the present embodiment, the operation plan creation unit 233 calculates the battery remaining life ratio in which the remaining life of the storage battery 13 is divided by the period from the present to the periodic inspection and maintenance time, but the present disclosure is not particularly limited to this. The operation plan creation unit 233 may calculate a subtraction value in which the period from the present to the periodic inspection and maintenance time is subtracted from the remaining life of the storage battery 13, and may create the operation plan of the plurality of electric vehicles 1 such that the electric vehicle 1 having a larger subtraction value has a longer operation distance and the electric vehicle 1 having a smaller subtraction value has a shorter operation distance.

In a case where the remaining life of the storage battery 13 is shorter than the period from the present to the periodic inspection and maintenance time, the sign of the subtraction value becomes negative, and in a case where the remaining life of the storage battery 13 is longer than the period from the present to the periodic inspection and maintenance time, the sign of the subtraction value becomes positive. The operation plan creation unit 233 may assign the operation route having a shortest operation distance to the electric vehicle 1 having the smallest subtraction value. The operation plan creation unit 233 may assign at least one operation route in ascending order from the shortest operation distance among the plurality of operation routes to at least one electric vehicle 1 having a subtraction value that is equal to or less than a predetermined value among the plurality of electric vehicles 1. Furthermore, the operation plan creation unit 233 may arrange the plurality of electric vehicles 1 in ascending order of subtraction value, arrange the plurality of operation routes in ascending order of operation distance, and assign the plurality of operation routes arranged in ascending order respectively to the plurality of electric vehicles 1 arranged in ascending order.

In the present embodiment, the operation plan creation unit 233 assigns a plurality of operation routes determined in advance to the plurality of electric vehicles 1, but the present disclosure is not particularly limited to this. The operation plan creation unit 233 may include an operation route creation unit that creates a plurality of operation routes. For example, the operation route creation unit may acquire a plurality of drop-by points at which the plurality of electric vehicles 1 should drop by, and create a plurality of operation routes passing through the plurality of acquired drop-by points.

In the present embodiment, the number of the plurality of electric vehicles 1 and the number of the plurality of operation routes are the same, but the present disclosure is not particularly limited to this. The number of the plurality of electric vehicles 1 may be larger than the number of the plurality of operation routes. In this case, the route assignment unit 244 does not need to operate the electric vehicle 1 having the smallest battery remaining life ratio. The route assignment unit 244 assigns the operation route to the same number of electric vehicles 1 as the operation routes.

In the above embodiment, each component may be implemented by being configured with dedicated hardware or by executing a software program suitable for each component. Each component may be implemented by a program execution unit such as a CPU or a processor reading and executing a software program recorded on a recording medium such as a hard disk or a semiconductor memory. The program may be carried out by another independent computer system by recording and transferring the program onto a recording medium or transferring the program via a network.

Some or all of the functions of the devices according to the embodiment of the present disclosure are implemented as large scale integration (LSI), which is typically an integrated circuit. These may be individually integrated into one chip, or may be integrated into one chip so as to include some or all of them. The integrated circuit is not limited to the LSI, and may be implemented by a dedicated circuit or a general-purpose processor. A field programmable gate array (FPGA) that can be programmed after manufacturing of LSI or a reconfigurable processor in which connections and settings of circuit cells inside LSI can be reconfigured may be used.

Some or all of the functions of the devices according to the embodiment of the present disclosure may be implemented by execution of a program by a processor such as a CPU.

The numbers used above are all exemplified to specifically describe the present disclosure, and the present disclosure is not limited to the exemplified numbers.

The order in which the steps indicated in the above flowchart is executed is exemplified for specifically describing the present disclosure, and may be an order other than the above order as long as a similar effect is obtained. Some of the above steps may be executed simultaneously (concurrently) with other steps.

### INDUSTRIAL APPLICABILITY

Since the technique according to the present disclosure can reduce the loss caused by halting the operation of an electric vehicle, it is useful for a technique for managing the operation of a plurality of electric vehicles.

1. A vehicle operation management method comprising, by a computer:
acquiring a periodic inspection and maintenance time determined in advance for each of a plurality of electric vehicles,
predicting a remaining life of each battery from a state of the battery of each of the plurality of electric vehicles, and
creating an operation plan of the plurality of electric vehicles based on the periodic inspection and maintenance time of each of the plurality of electric vehicles and the remaining life of each of the plurality of electric vehicles.

2. The vehicle operation management method according to claim 1, wherein in creating the operation plan, the operation plan of the plurality of electric vehicles is created such that an electric vehicle having a remaining life that is longer compared with a period from present to the periodic inspection and maintenance time has a longer operation distance, and an electric vehicle having a remaining life that is shorter compared with a period from present to the periodic inspection and maintenance time has a shorter operation distance.

3. The vehicle operation management method according to claim 2, wherein in creating the operation plan, a remaining life ratio is calculated by dividing the remaining life by a period from present to the periodic inspection and maintenance time, and an operation plan of the plurality of electric vehicles is created such that an electric vehicle having the remaining life ratio that is larger has a longer operation distance and an electric vehicle having the remaining life ratio that is smaller has a shorter operation distance.

4. The vehicle operation management method according to claim 3, wherein in creating the operation plan, a plurality of operation routes determined in advance are assigned to the plurality of electric vehicles.

5. The vehicle operation management method according to claim 4, wherein in creating the operation plan, an operation route having a shortest operation distance is assigned to the electric vehicle having the remaining life ratio that is smallest.

6. The vehicle operation management method according to claim 4, wherein in creating the operation plan, at least one operation route in ascending order from the shortest operation distance among the plurality of operation routes is assigned to at least one electric vehicle having the remaining life ratio that is equal to or less than a predetermined value among the plurality of electric vehicles.

7. The vehicle operation management method according to claim 4, wherein in creating the operation plan, a predetermined number of operation routes arranged in order from an operation route having a shortest operation distance among the plurality of operation routes are assigned to a predetermined number of electric vehicles arranged in order from an electric vehicle having the remaining life ratio that is smallest among the plurality of electric vehicles.

8. The vehicle operation management method according to claim 4, wherein in creating the operation plan, the plurality of electric vehicles are arranged in ascending order of the remaining life ratio, the plurality of operation routes are arranged in ascending order of operation distance, and the plurality of operation routes arranged in ascending order are assigned respectively to the plurality of electric vehicles arranged in ascending order.

9. The vehicle operation management method according to claim 1, wherein in creating the operation plan, when a plurality of periodic inspection and maintenance times are acquired for one electric vehicle, the periodic inspection and maintenance time that is closest to a predicted replacement time until the remaining life elapses from present is selected from among the plurality of periodic inspection and maintenance times.

10. A vehicle operation management device comprising:
an acquisition unit that acquires a periodic inspection and maintenance time determined in advance for each of a plurality of electric vehicles;
a prediction unit that predicts a remaining life of each battery from a state of the battery of each of the plurality of electric vehicles; and
a creation unit that creates an operation plan of the plurality of electric vehicles based on the periodic inspection and maintenance time of each of the plurality of electric vehicles and the remaining life of each of the plurality of electric vehicles.

11. A non-transitory computer readable recording medium storing a vehicle operation management program that causes a computer to function to:
acquire a periodic inspection and maintenance time determined in advance for each of a plurality of electric vehicles;
predict a remaining life of each battery from a state of the battery of each of the plurality of electric vehicles; and
create an operation plan of the plurality of electric vehicles based on the periodic inspection and maintenance time of each of the plurality of electric vehicles and the remaining life of each of the plurality of electric vehicles.
